(19) United States
(12) Patent Application Publication
(10) Pub. No.: US 2012/0306225 A1
(43) Pub. Date: Dec. 6, 2012

(54) Leaf scooper

(76) Inventor: Shapoor Mivzai Mirzai, Hayward, CA (US)

(21) Appl. No.: 12/660,473

(22) Filed: Feb. 26, 2010

(51) Int. Cl. B66C 1/44

(52) U.S. Cl. 294/104

(57) ABSTRACT

The present invention relates to a leaf scooping device and mechanism that allows the easy pick up of leaves and other debris. The device consists of a first receiving or holding section and an entrapment section situated at the distal end of the device whereas the entrapment section can be operated by a convenient lever handle positioned at the proximal end of the device

### CROSS-REFERENCE TO RELATED APPLICATIONS

Not applicable

### FEDERALLY SPONSORED RESEARCH OR DEVELOPMENT Not applicable

### PARTIES TO A JOINT RESEARCH AGREEMENT Not applicable

### REFERENCE TO A SEQUENCE LISTING, A TABLE, OR A COMPUTER LISTING Not applicable

### BACKGROUND OF THE INVENTION

1. Field of Invention

The present invention relates to the field of gardening rakes, more particularly to a leaf scooper that can entrap dead leaves and other debris in an efficient manner.

2. Description of the Related Art

Fallen leaves and other debris are a major hassle that most homeowners and gardeners face during autumn. A traditional garden rake is known in the art. These rakes are not efficient in collecting and transporting debris and fallen leaves which tend to fall off while being collected. One has to use a rake to gather the leaves into a pile and then transfer them into a garbage bag. The task becomes even more tedious as gusts of wind blow leaves from the pile. Implements such as garden rakes combined or used in combination with a spade are known in the art.

U.S. Pat. No. 5,564,267 (Leaf Pro Inc, 2000) describes a device that uses two shafts to combine a rake and a shovel by means of a pivot joint. This design is cumbersome to use as the user has to utilize both hands to operate the device. Also the rake head does not allow for collection of a substantial amount of debris and leaves.

U.S. Pat. No. 6,619,023 (Marcone, 2003) describes a shovel rake that has a rake and an adjustable shovel that can be locked into position on the opposite end of the rake when not in use. The implement is not useful if one wants to collect a large number of leaves and other debris between the shovel and the rake.

Most rakes have tines that allow many leaves and other smaller debris to fall off, thus not achieving complete cleanliness as desired. The prior art mentioned has many limitations such as the devices do not allow for a large amount of debris and leaves to be collected. Also, handling such devices requires the user to utilize both hands causing much inconvenience. To overcome all these limitations, an invention is proposed herein with several embodiments, which will try to overcome all the limitations of past products.

### SUMMARY OF THE INVENTION

The disclosed invention overcomes the limitations of leaf collecting rakes. One of the objects of the present invention is to provide a leaf scooper that allows for the smooth and effortless collection of leaves and other debris without much effort on the par of the user.

Another object of the invention is to provide a leaf scooper that allows for collection of a larger amount of debris and leaves as compared to other rakes.

Yet another object of the invention is to provide a leaf scooper that allows for proper capture of the debris and leaves and prevents the same from falling and thus reducing the time required for the task.

Another object of the present invention is to provide for a leaf scooper that has a mechanism that allows for proper capture of the debris and dirt that allows the user to open and close the capturing device easily.

Yet another object of the present invention is to provide a leaf scooper that is light in weight.

Another object of the present invention is to provide a durable and cost effective leaf scooping device.

### BRIEF DESCRIPTION OF PREFERRED EMBODIMENTS

Preferred embodiments are illustrated by way of example, and not by way of limitation, in the accompanying drawings and in which like reference numerals refer to similar elements and in which:

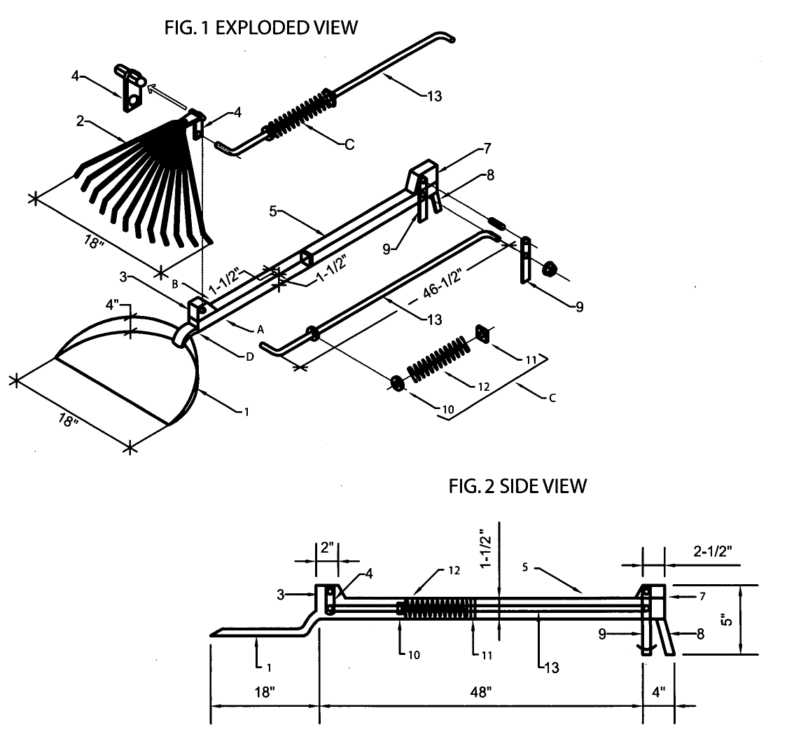

FIG. 1 shows a perspective side view of the leaf scooper of an embodiment of the present invention.

FIG. 2 shows an inset view of the operating mechanism of an embodiment of the present invention.

### DETAILED DESCRIPTION OF PREFERRED EMBODIMENTS

The present invention relates to a leaf scooper. Before describing the embodiments and specially the preferred embodiments of the invention in detail, it is to be understood that other embodiments may be used and structural and functional modifications may be made without departing from the spirit or scope of the invention. Those skilled in the art will readily appreciate that the detailed description given herein with respect to these drawings is for explanatory purposes as the invention extends beyond those limited embodiments.

With reference to the drawings in particular to FIG. 1 and FIG. 2 describes in general the invention leaf scoopers and its various embodiments in numerals and alphabets.

As illustrated in FIG. 1 the leaf scooper comprises of an upper trapping section 2 attached to a hinge 4 and housed in chamber 3. The lower holding section 1 is attached to the distal end of the hollow chamber at D and the said hollow section is in turn attached to the hollow shaft A at B. The hollow shaft 5 at the proximal end ends in a knob 7 that further extends into two extremities 8 and 9.

FIG. 2 illustrates the working of the spring mechanism C that is housed in hollow shaft 5, the said spring mechanism C comprises of a nut 10 and a washer 11 at the distal end of the said mechanism, behind the nut at the distal end is spring 12 and a metal wire 13 that is attached from the hinge 4 and passes through nut 10 and washer 11 through spring 12 and along the entire length of hollow shaft 5 and ends in knob 7 which in turn is controlled by handles 8 and 9.

When the user works handles 8 and 9, the wire 13 is pulled along which in turn pulls the spring 12 and which in turn results in the pulling movement of the hinge 4 which results in the descent of upper trapping device onto the lower holding section thus trapping leaves and other debris within the device. The upper trapping device 2 descends on the outer extremities of the lower holding section 1 thus ensuring that debris and smaller leaves do not fall off.

In order to release the leaves and other debris into a garbage bay the user works the handles 8 and 9 again so as to release spring 12 and thus allowing hinge 4 to return to its original position and thus raising the upper trapping device 2 to release contents such as leaves and other debris.

The lower holding section 1 is a semi-circular pan-like structure that has lips that extend laterally from the arched side of the pan on the periphery and an open edge at the diameter of the semi-circle at the distal end which is used to gather leaves and other debris, alternatively the shape of the pan could also be oval, square or any other geometric shape. The lower holding device 1 could be made of any light weight metal, more preferably aluminum; this makes the device light yet durable and strong, capable of carrying substantially large amounts of leaves and other debris.

The upper trapping device 2 is made up of a plurality of tines that are made of light weight metal, more preferably aluminum. The chamber 3 that houses hinge 4 could be made from plastic or other similar material that is durable and strong and economically viable, alternatively it could be constructed from aluminum or other light weight metal.

The knob 7 and handles 8 and 9 could be made of plastic, wood, metal etc., more preferably plastic.

The wire 13 that passes through the entire length of the device could be made of any metal that has durability and load bearing capacity, preferably standard wires used in the art, more preferably steel wires, as these are more durable and have high load bearing capacity.

The leaf scooper could be made of plastic in different colors thus making the device more attractive and appealing. Alternatively, a combination of aluminum or fiberglass would also be used to give the product a classic and appealing look. Most preferably the leaf scooper could be made from a light weight metal such as aluminum in combination with plastic, as aluminum is light weight and durable.

Any method of production that is known in the art can be used to manufacture the product in a cost effective manner. The leaf scooper can be used to lift leaves and other debris as well as other garbage such as bottles and cans. With respect to the above description it is apparent that the invention can be made in various dimensional shapes, forms, functions and methods of operation, method of manufacture and method of use and therefore all equivalent relationships to those illustrated in the drawings and described in the specification are intended to be encompassed by the present inventions.

I claim:

1. A leaf scooping device comprising of:
1. A lower holding device extending from the distal end of a hollow chamber attached to the distal end of an elongated shaft.
2. An upper trapping device that is surmounted on the said shaft by means of a hinge housed in the said hollow channel at the distal end.
3. An operating mechanism situated within the hollow shaft,
Such that on working the said mechanism the upper trapping device descends onto the lower holding device enabling collection of leaves and debris.

2. A leaf scooping device as claimed in claim 1 wherein, the operating mechanism comprises of a hinge, the distal end of which is attached to the said upper trapping device and proximal end attached to said hollow shaft by means of a metal wire, the said metal wire then passes through a spring mechanism such that when the user pulls the handle at the proximal end of the shaft, the said upper trapping device descends onto the lower holding device.

3. A leaf scooping device as claimed in claim 1 wherein, the said spring mechanism comprises of a metal wire attached to the proximal end of said hinge, by a nut, a washer and spring at the distal end of the shaft and attached to a knob at the proximal end of the shaft.

4. A leaf scooping device as claimed in claim 1 wherein, the said lever mechanism comprises of at least one handle and the said handle allows for the movement of the said upper trapping device through the handle's connection to the said knob of the operating mechanism.

5. A leaf scooping device as claimed in claim 1 wherein, the upper trapping device has a plurality of tines attached to a frame, which is attached to the said hinge and the said tines extend upwards or downward at the distal end of the said upper trapping device.

6. A leaf scooping device as claimed in claim 1 wherein, the upper trapping device could be made from metal such as iron or from any other light weight metal such as aluminum or from high quality plastic, more preferably from aluminum.

7. A leaf scooping device as claimed in claim 1 wherein, the lower holding section comprises of a geometrically shaped pan having a lip on the outer periphery of the said pan, and an open edge at the distal end and attached to the hollow chamber.

8. A leaf scooping device as claimed in claim 1 wherein, the lower holding device could be of any geometrical shape among square, rectangle, oval etc., more preferably semi-circular.

9. A leaf scooping device as claimed in claim 1 wherein, the said lower holding device could be made from any light weight metal or from plastic more preferably from aluminum.

10. A leaf scooping device as claimed in any one of the preceding claims wherein, the length of the said shaft could vary from 1 to 10 feet.

11. A leaf scooping device as claimed in any of the preceding claims wherein, the device could be made of any light weight metal that is durable, more preferably from aluminum.

12. A leaf scooping device as claimed in any of the preceding claims wherein, the device could be made from plastic or similar material.

13. A leaf scooping device as claimed in any of the preceding claims wherein, the said device could be made from a combination of metal and plastic.

14. A leaf scooping device as claimed in any of the preceding claims wherein, the said metal wire could be made of any durable metal, more preferably metal alloy such as steel.

15. A method of using the said leaf scooping device.
